(19) United States
(12) Patent Application Publication
(10) Pub. No.: US 2025/0183632 A1
(43) Pub. Date: Jun. 5, 2025

(54) CABLE STRIPPING ASSEMBLY INCLUDING A BUSHING COVER

(71) Applicant: MILWAUKEE ELECTRIC TOOL CORPORATION, Brookfield, WI (US)

(72) Inventors: Joseph C. ILLG, Grafton, WI (US); Joseph J. PECHSTEIN, West Bend, WI (US); Joseph W. REMSCHAK, Greenfield, WI (US)

(21) Appl. No.: 18/965,278

(22) Filed: Dec. 2, 2024

Related U.S. Application Data
(60) Provisional application No. 63/605,810, filed on Dec. 4, 2023.

(51) Int. Cl. H02G 1/12

(52) U.S. Cl. CPC H02G 1/1265

(57) ABSTRACT

A cable stripping tool assembly may include a cable stripping tool including a housing and a drive mechanism disposed in the housing. A cable stripping tool assembly may include a bushing supported on the housing for rotation about a longitudinal axis by the drive mechanism, the bushing having a blade assembly engageable with a cable for stripping an insulation layer therefrom. A cable stripping tool assembly may include a cover coupled to the bushing opposite the housing and supported for rotation about the longitudinal axis relative to the bushing, the cover including a contact surface configured to engage a stop member to inhibit rotation of the cover with respect to the cable.

### CROSS-REFERENCE RELATED APPLICATIONS

This application claims priority to U.S. Provisional Patent Application No. 63/605,810, filed on Dec. 4, 2023, the entire contents of which are incorporated herein by reference.

### FIELD OF THE INVENTION

The present invention relates to cable strippers, and more particularly systems and methods for stripping a cable jacket from a sheathed cable.

### BACKGROUND OF THE INVENTION

Electrical cables are commonly used to transfer electrical energy from power sources, such as a power grid, a power plant, and/or a generator. Other cables may be used to transfer an electrical signal from one location to another. Some cables include thick conductive cores surrounded by a network of minor conductors and encased by a cable jacket that facilitates the prevention of interference caused by direct contact with the cable, and that shields the cable from the environment. The combination of the rigidity of the cable jacket and the materials surrounding the core of the cables may make such cables unwieldy and/or difficult to bend or to reshape.

### SUMMARY OF THE INVENTION

The present invention provides, in one aspect, a cable stripping tool assembly including a cable stripping tool, a bushing, and a cover. The cable stripping tool includes a housing and a drive mechanism disposed in the housing. The bushing is supported on the housing for rotation about a longitudinal axis by the drive mechanism and has a blade assembly engageable with a cable for stripping an insulation layer therefrom. The cover is coupled to the bushing opposite the housing and supported for rotation about the longitudinal axis relative to the bushing. The cover includes a contact surface configured to engage a stop member to inhibit rotation of the cover with respect to the cable.

In some aspects, the housing includes a coupling member that is rotatable about the longitudinal axis by the drive mechanism and configured to receive the bushing when the bushing is coupled to the housing.

In some aspects, the contact surface is formed on a front face of the cover.

In some aspects, the contact surface is part of an outer surface.

In some aspects, the contact surface includes tabs.

In some aspects, the techniques described herein relate to a cable stripping tool assembly including: a cable stripping tool including a housing and a drive mechanism disposed in the housing; a bushing supported on the housing for rotation about a longitudinal axis by the drive mechanism, the bushing having a blade assembly engageable with a cable for stripping an insulation layer therefrom; and a cover coupled to the bushing opposite the housing and supported for rotation about the longitudinal axis relative to the bushing, the cover including a contact surface configured to engage a stop member to inhibit rotation of the cover with respect to the cable.

In some aspects, the techniques described herein relate to a cable stripping tool assembly including: a cable stripping tool including a housing and a drive mechanism disposed in the housing; a bushing supported on the housing for rotation about a longitudinal axis by the drive mechanism, the bushing having a blade assembly engageable with a cable for stripping an insulation layer therefrom, the bushing including a first end coupled to the housing and a second end opposite the first end; and a cover coupled to the bushing opposite the housing and supported for rotation about the longitudinal axis relative to the bushing, the cover including a first end rotatably coupled to the bushing and a second end spaced apart from the first end, the second end of the cover offset from the second end of the bushing, the cover including a contact surface configured to engage a stop member to inhibit rotation of the cover with respect to the cable.

In some aspects, the techniques described herein relate to a kit for use with a cable stripping tool assembly, the cable stripping tool assembly including a cable stripping tool and a bushing, the cable stripping tool including a housing and a drive mechanism disposed in the housing, the bushing supported on the housing for rotation about a longitudinal axis by the drive mechanism, the bushing having a blade assembly engageable with a cable for stripping an insulation layer therefrom, the kit including: a first cover including a first end configured to be coupled to the bushing; a second end opposite a first end; a channel extending between the first end and the second end; and a first contact surface configured to engage a stop member to inhibit rotation of the first cover with respect to the cable; and a second cover including a first end configured to be coupled to the bushing; a second end opposite a first end; a channel extending between the first end and the second end; and a second contact surface configured to engage a stop member to inhibit rotation of the second cover with respect to the cable, wherein the first cover and the second cover are alternately couplable to the bushing, and wherein the second cover has a different configuration than the first cover.

Other features and aspects of the invention will become apparent by consideration of the following detailed description and accompanying drawings.

### BRIEF DESCRIPTION OF THE DRAWINGS

FIG. 1 is a perspective view of a cable with a cable jacket surrounding a plurality of conductors.

FIG. 2 is a perspective view of a cable with a portion of the cable jacket removed exposing conductors on an end portion of the cable.

FIG. 3 is a perspective view of a cable stripping assembly according to one embodiment, the assembly including a cable stripping tool, a bushing removably coupled to the cable stripping tool, and a first embodiment of a cover coupled to the bushing.

FIG. 4 is a schematic cross-sectional view of an exemplary cable stripping assembly.

FIG. 5 is a schematic cross-sectional view of the cable stripping assembly of FIG. 4 with a cable inserted and a stop member on the cable.

FIG. 6 is a perspective view a stage of operation of the cable stripping assembly of FIG. 5 with the cover engaging the stop member.

FIG. 7A-7F illustrate two sizes of the cover of FIG. 3 for use in the cable stripping assembly.

FIG. 8A-8F illustrate two additional sizes of the cover of FIG. 3 for use in the cable stripping assembly.

FIG. 9A-9F illustrate two sizes of a second embodiment of a cover for use in the cable stripping assembly of FIG. 3.

FIG. 10A illustrates a first stage of operation of an exemplary cable stripping tool, with the embodiments of the cover of FIGS. 9A-9F coupled to the bushing and the cable stripping assembly is spaced from a user's hand.

FIG. 10B illustrates a further stage of operation of the cable stripping assembly of FIG. 5 with the cover adjacent a stop surface of the user's hand.

FIG. 10C illustrates a further stage of operation of the cable stripping assembly of FIG. 5 with the cover contacting the stop surface of the user's hand.

FIG. 11A-11F illustrate two sizes of a third embodiment of a cover for use in the cable stripping assembly of FIG. 3.

FIG. 12A-12F illustrate two sizes of a fourth embodiment of a cover for use in the cable stripping assembly of FIG. 3.

FIG. 13A-H illustrate two sizes of a fifth embodiment of a cover for use in the cable stripping assembly of FIG. 3.

FIG. 14A-H illustrate two sizes of a sixth embodiment of a cover for use in the cable stripping assembly of FIG. 3.

FIG. 15 illustrates the covers of FIGS. 8A-8F and 11A-14H as part of a kit for use with the cable stripping assembly of FIG. 3.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

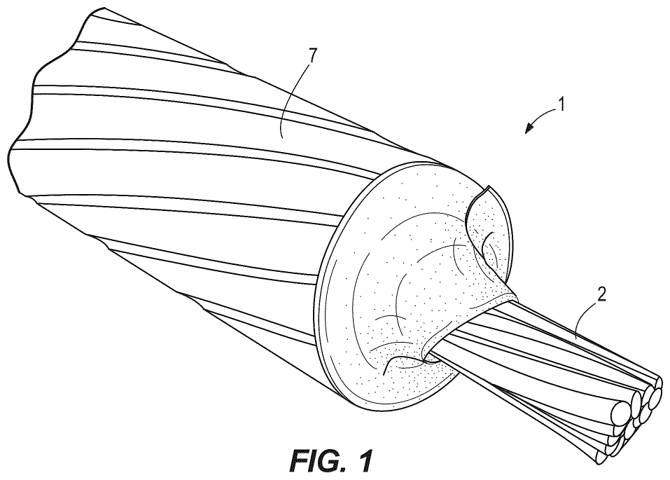

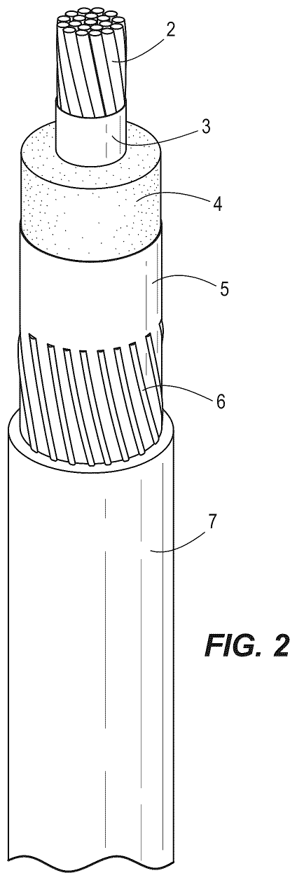

With reference to FIGS. 1 and 2, an exemplary cable 1 includes a plurality of conductors 2 surrounded and supported by a first semi-conductive layer 3, an insulation layer 4, a second semi-conducting layer 5, a plurality of neutrals 6, and an outer jacket 7. The cable 1 is a sheathed cable that may vary in size depending on load and voltage requirements. In order to connect multiple cables for electrical communication therebetween, the outer jacket 7 and second semi-conducting layer 5 are first removed. Then, the conductors 2 are exposed by removing the first semi-conductive layer 3 and the insulation layer 4. As seen in FIG. 2, the first semi-conductive layer 3 and the insulation layer 4 may be helically scored and removed to expose an end length 8 of the cable 1. The conductors 2 may include multiple subsets of different types, sizes, etc. of conductor. The multiple subsets may be separated by internal insulative material. In some embodiments, the conductors 2 can be connected with a crimped lug. In some embodiments, the cable 1 may include a single conductor 2. The neutrals may be braided or have other configurations. The illustrated cable 1 is only one possible type of cable, and other alternative arrangements or styles of cable may also be used.

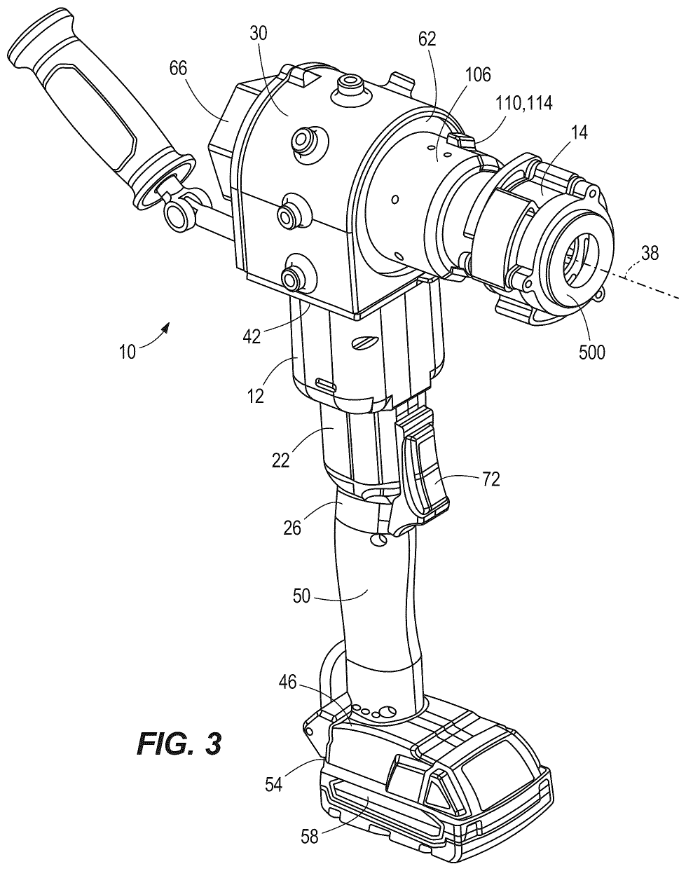

FIGS. 3-15 illustrate various embodiments of cable stripping assembly 10 including a cover.

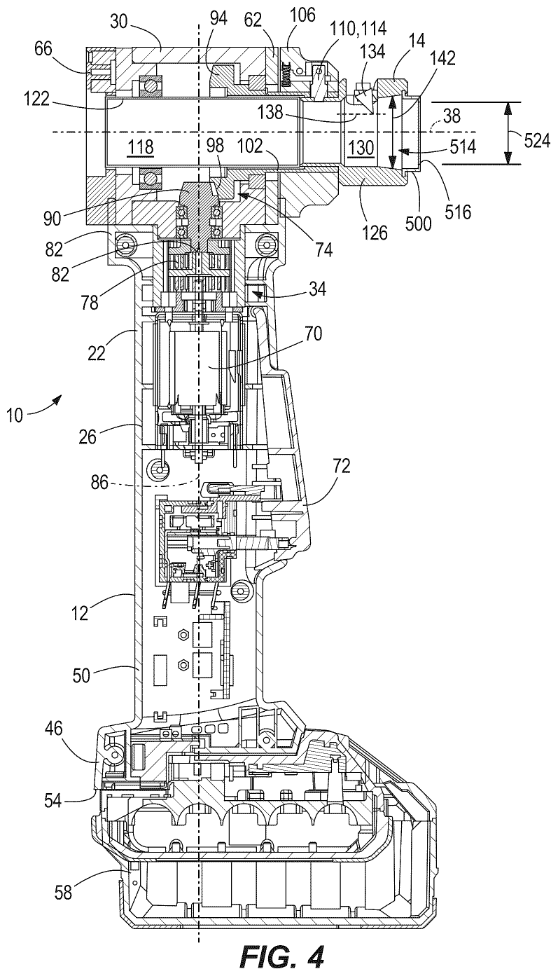

As seen in FIGS. 3 and 4, the cable stripping assembly 10 includes a stripper tool 12, a bushing 14, and a cover 500. FIGS. 3 and 4 illustrate exemplary embodiments of the assembly 10, however, the tool 12, bushing 14, and cover 500 are not limited to the embodiments described and illustrated herein and may include variations not specifically described. Additionally, the cover 500 illustrated in FIG. 3 is a first embodiment of a first type of cover. Additional embodiments and types of covers are described in further detail below.

Turning to FIGS. 3 and 4, the stripping tool includes a housing 22 having a main body 26 and a head 30. The bushing 14 is removably coupled to the head 30 and strips a cable (e.g., the cable 1 of FIG. 1) by scoring and removing the first semi-conductive layer 3 and the insulation layer 4 to expose the conductors 2, after the cable jacket 7 and the second semi-conductive layer 5 have already been removed in a separate step. In some embodiments, the bushing 14 may not be removable from the head 30. A drive mechanism 34 is positioned within the housing 22 and is coupled to the bushing 14 to rotate the bushing 14 about a longitudinal axis 38 defined by the head 30. The cover 500 is coupled to the bushing 14 opposite the stripper tool 12 and is supported on the bushing 14 for rotation about the longitudinal axis 38 relative to the bushing 14.

The main body 26 of the housing 22 extends between a body first end 42 and a body second end 46 and includes a grip surface 50 formed between the body first end 42 and the body second end 46. In the illustrated embodiment, a battery receptacle 54 is positioned at the body second end 46 and the assembly 10 includes a battery pack 58 removably couplable to the battery receptacle 54. In some embodiments, the battery pack 58 is a rechargeable power tool battery pack, such as an 18-volt Lithium-Ion battery pack. In other embodiments, other types of batteries may be used. In still other embodiments, the tool 12 may be corded. The head 30 extends between a front end 62 and a rear end 66. In the illustrated embodiment, the head 30 is coupled to the body first end 42 of the main body 26 between the front end 62 and rear end 66 of the head.

As shown in FIG. 4, the drive mechanism 34 includes a motor 70 and a drive train 74. The motor 70 includes a transmission 78 terminating in an output shaft 82 driven to rotate about a motor axis 86. The motor 70 may be controlled by a user interface including a switch 72 positioned on the grip surface 50. In the illustrated embodiment, the switch 72 is a paddle style trigger. In other embodiments, other types of triggers may be used. The user interface may include additional components relating to control of the tool 12. For example, in some embodiments, the motor 70 is operable to drive in forward and reverse and the user interface may include an actuator to select the drive mode. The drive train 74 is connected between the motor 70 and the bushing 14 to transmit rotation from the motor 70 to the bushing 14. The drive train 74 includes a bevel pinion 90 mounted on the output shaft 82 to co-rotate therewith. In the illustrated embodiment, the motor 70 is oriented with the motor axis 86 transverse to the longitudinal axis 38 and is positioned within the main body 26 of the housing 22 adjacent the body first end 42 with the output shaft 82 extending into the head 30 of the housing 22. In other embodiments, the motor axis 86 may be parallel to the longitudinal axis, and the bevel pinion 90 may be replaced with a different type of gear (e.g., a spur gear). The drive train 74 further includes a drive member 94 supported by the head 30 for rotation about the longitudinal axis 38. The drive member 94 includes a bevel gear 98 engaged by the bevel pinion 90, an integral collar 102 extending from the bevel gear 98 out of the front end 62 of the head 30, and a coupling member 106 supported on the integral collar 102 to rotate about the longitudinal axis 38. In some embodiments, the longitudinal axis 38 is defined by the coupling member 106. In some embodiments the bevel gear 98 is ring shaped is generally concentric to the longitudinal axis 38. the. In some embodiments, the drive train 74 may include substantially different components to transmit rotation from the motor 70 to the bushing 14.

The bushing 14 is removably coupled to the coupling member 106 to rotate therewith. The coupling member 106 includes a retainer 110 that selectively secures the bushing 14 on the tool 12. In the illustrated embodiment, the retainer 110 is a quick release mechanism 114 that engages a portion of the bushing 14 fitted into the coupling member 106 to prevent axial movement of the bushing 14 relative to the coupling member 106 and lock the bushing 14 for corotation with the coupling member 106. In other embodiments, other coupling methods may be used to secure the bushing 14 to the tool 12 and transmit rotation from the coupling member 106 to the bushing 14.

With continued reference to FIG. 4, the head 30 further defines a channel 118 extending therethrough. In the illustrated embodiment, the channel 118 is formed by a tube 122 supported in the head 30. In other embodiments, the channel 118 may be integrally formed in the housing 22, may be formed in multiple components supported in the head 30, or may be formed by a combination of the housing 22, tube 122, or other components.

The bushing 14 includes a body 126, a front bushing end 126a, a rear bushing end 126b, a central opening 130 extending through the body 126 between the front bushing end 126a and the rear bushing end 126b, and a blade assembly 134 mounted to the body 126 to extend into the central opening 130 by a cutting depth 138. When the bushing 14 is coupled to the tool 12, the central opening 130 extends along the longitudinal axis 38. The central opening 130 has an internal diameter 142 measured between inner walls. The cutting depth 138 may be measured from the inner walls of the body 126 toward the longitudinal axis 38. As discussed above, the bushing 14 shown in FIG. 4 is an exemplary embodiment and may take other forms. In the embodiment shown in FIG. 4, the bushing 14 may be one of several sizes of bushing 14 which are alternately coupled to the tool 12. Each bushing 14 may include different cutting depths 138 and/or different internal diameters 142 of the central opening to accommodate different sizes of cable 1 with different thicknesses of layers 3, 4. In other embodiments, including the embodiment shown in FIG. 3, the bushing 14 may be adjustable and may be configured to alter a cutting depth and/or an internal diameter of the central opening. An exemplary adjustable bushing is disclosed in co-pending U.S. patent application Ser. No. 18/758,459 filed on Jun. 28, 2024, which claims priority to Provisional Application No. 63/511,025 filed Jun. 29, 2023, the entire contents of each of which are incorporated herein by reference.

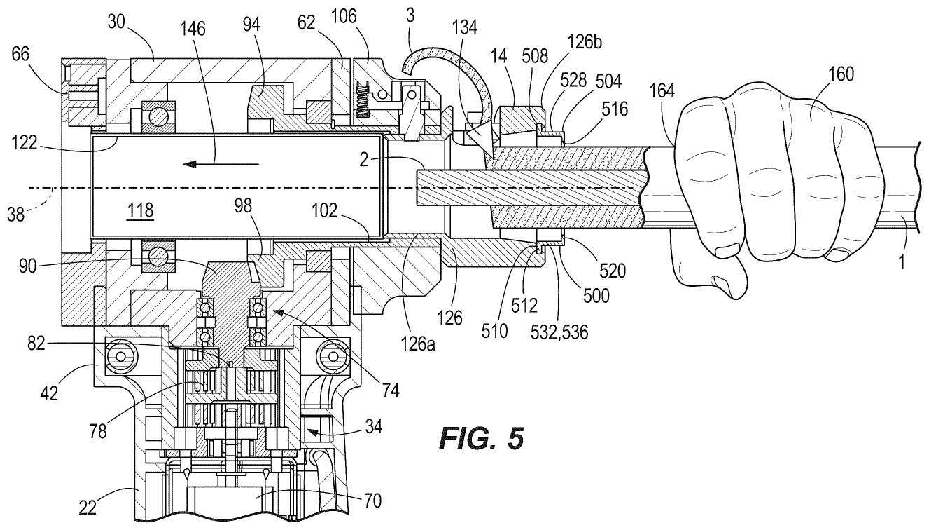

With reference to FIGS. 4 and 5, the cover 500 is coupled to the bushing 14. In some embodiments, the cover 500 is removably coupled to the bushing 14. In other embodiments, the cover 500 may be designed to remain coupled to the bushing 14 and be stored and transported therewith. The cover 500 extends along the longitudinal axis 38 between a cover front end 504 and a cover rear end 508. A rear flange 512 is formed at or adjacent to the cover rear end 508 and is positioned in a groove 510 in the bushing 14. The rear flange 512 is rotatably supported within the groove 510 to allow rotation of the cover 500 with respect to the bushing 14. In other embodiments, the cover 500 may include additional or alternate coupling features at the rear end 508 to secure the cover 500 to the bushing 14. When the cover rear end 508 is coupled to the bushing 14, the cover front end 504 is offset from the bushing 14 (e.g., the bushing front end 126a). The cover 500 includes a cover channel 514 extending between the cover rear end 508 and the cover front end 504. The cover front end 504 defines a front face 520. A front opening 516 is defined in the front face 520 of the cover 500 and provides access to the cover channel 514. The front opening 516 has an opening diameter 524 which may limit the width of cable inserted into the cover channel 514 and thus to the bushing 14. The cover 500 further includes a central body 528 defining an outer surface 532. In the illustrated embodiment, the outer surface 532 includes a cylindrical surface 536.

With reference to FIG. 5, during a stripping operation the cable 1 is inserted through the assembly 10 along a pathway 146. In the illustrated embodiment, pathway 146 is partially defined by the channel 118 formed by the tube 122 in the head 30, the central opening 130 of the bushing 14, and the cover channel 514 of the cover 500. An entrance to the pathway 146 is formed by the front opening 516 of the cover 500. An exit of the pathway 146 is formed at the rear end 66 of the head 30.

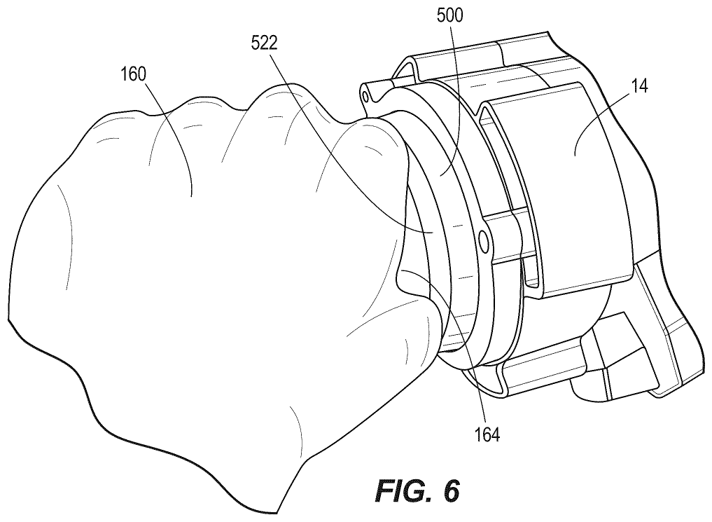

Turning to FIG. 6, to initiate the stripping operation, the operator feeds the cable into the pathway 146 of the assembly 10 by inserting the cable 1 into the front opening 516 of the cover 500, through the cover channel 514 and into the central opening 130 of the bushing 14 until the pathway 146 intersects the blade assembly 134. The operator presses the switch 72 to actuator the motor 70 to rotate the bevel pinion 90 through the transmission 78. In some embodiments, the motor 70 is actuated before the cable 1 is inserted along the pathway 146. Rotation is transmitted from the bevel pinion 90 to the bevel gear 98 of the drive member 94. The bevel gear 98 drives the external collar and the coupling member 106 to rotate about the longitudinal axis 38. Rotation of the coupling member 106 is transmitted to the bushing 14 by the retainer 110, and the bushing 14, including the blade assembly 134, rotates about the longitudinal axis 38. The rotation of the blade assembly 134 cuts or scores the layers 3, 4, exposing the conductors 2 at the end 6 of the cable 1.

With reference to FIGS. 5 and 6, the stripping operation continues as the operator advances the assembly 10 along the cable 1. The combination of rotation of the blade assembly 134 and movement of the cable along the pathway 146 creates a spiral score mark in the cable layers 3, 4 and the bushing 14 separates the layers 3, 4 forming a coil and exposing the conductors 2. The cable stripping operation may have a defined stop point, defining the length of cable to be stripped, or the amount of cable layers 3, 4 to be removed. In the illustrated embodiments, the stop point may be marked by a stop member 160 coupled to the cable. For example, a user may grip the cable with the hand not positioned on the grip surface 50 and the fist created by the grip may act as the stop member 160. The stop member 160 includes a stop surface 164 (e.g., the surface closest to the end of the cable 1). In other embodiments, the stop member 160 may be a separate component (e.g., a ring, a flange, a projection, a boss, etc.) that is coupled to or clamped to the cable 1. The stop member 160 is coupled to the cable 1 to inhibit the stop member 160 from moving axially along the cable.

FIGS. 5-6 illustrate the process of terminating the stripping operation using the cover 500. In FIG. 5, the bushing 14 continues rotating and the assembly 10 travels along the cable. With reference to FIG. 6, as the assembly 10 approaches the stop point, the front face 520 of the cover 500 is adjacent to and then comes into contact with the stop surface 164 of the stop member 160. The front face 520 forms a contact surface 522 of the cover 500 that engages the stop surface 164. In some embodiments, the contact surface 522 is a high friction surface and the engagement of the stop surface 164 and the contact surface 522 inhibits movement of the cover 500 with respect to the stop member 160 and the cable 1. In some embodiments, the high-friction surface may be an over mold material formed from rubber or another suitable material. The bushing 14 therefore rotates with respect to the cover 500 and the blade assembly 134 continues to circumnavigate the cable 1. The stop member 160 is inhibited from moving along the cable 1 and therefore applies an axial force to the assembly 10 to inhibit the assembly 10 from moving along the cable 1. Thus, rotation of the bushing 14 moves the blade assembly 134 to create a circumferential cut, separating the coil of removed cable layers 3, 4 from the cable 1. Once the coil 3 has been removed, the exposed cable end 6 can travel the pathway 146 in reverse, and the assembly 10 can be removed from the cable 1. In some embodiments, the reverse movement may come from a reverse movement of the motor 70.

The cover 500 advantageously decreases friction between the bushing 14 and the stop member 160, which results in a cleaner cut and less rubbing on the stop surface 164 of the stop member 160. This is especially beneficial when the stop member 160 is formed by an operator's fist. In embodiments without the cover, the bushing 14 may rotate directly against the surface of the hand of the operator, resulting in chafed or pinched skin. Therefore, the cover 500 isolates the stop member 160 from rotation of the bushing 14.

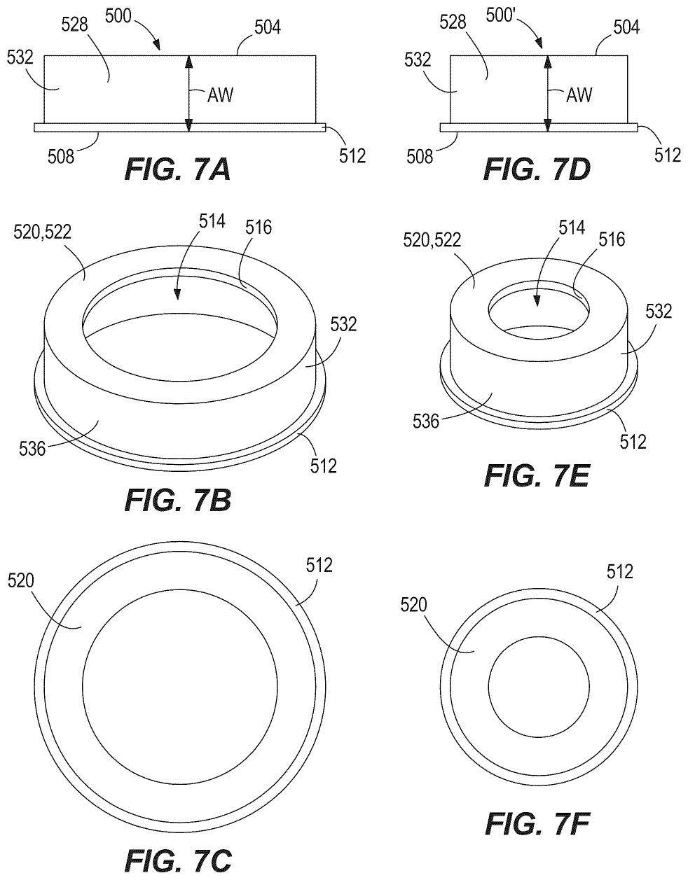

FIGS. 7A-9F and FIGS. 11A-15 illustrate various embodiments of covers for use with the cable stripping assembly 10.

FIGS. 7A-7C illustrate the first embodiment of the cover 500 illustrated in FIGS. 3-6, including the cover front end 504 with the front face 520 and front opening 516 and the rear end 508 with the flange 512. As discussed above, the central body 528 includes the cylindrical surface 536. The cover 500 has an axial width AW measured between the front end 504 and the rear end 508. The first style of cover 500 may come in additional sizes, for example, to enable coupling to different sizes of bushings 14 or for use with different sizes of tool 12. As seen in FIGS. 7D-7F, in a second embodiment of the first style of cover 500′, the cover 500′ is radially narrower than the cover 500. The axial width AW of the cover 500′ is the same as the axial width AW of the cover 500. The axial width AW may control the distance between the stop surface 164 of the stop member 160 and the stop point where the cable layers 3, 4 is fully separated from the cable 1.

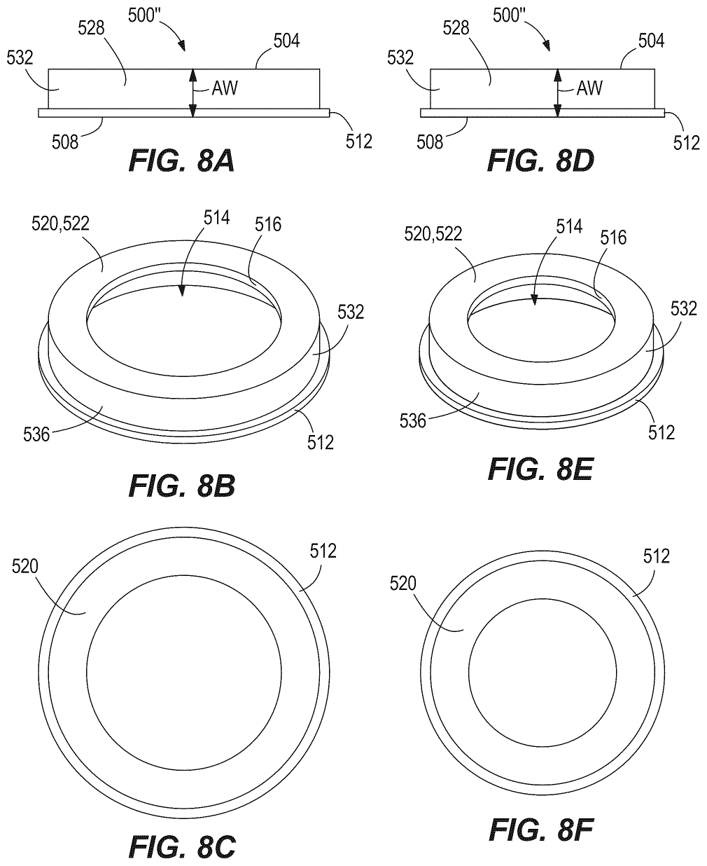

As seen in FIGS. 8A-8F, some embodiments of the first style of cover 500 also have different axial widths AW′. Specifically, FIGS. 8A-8F illustrate a cover 500″ with a smaller axial width AW′. The smaller axial width AW′ creates a smaller distance between the stop surface and the stop point.

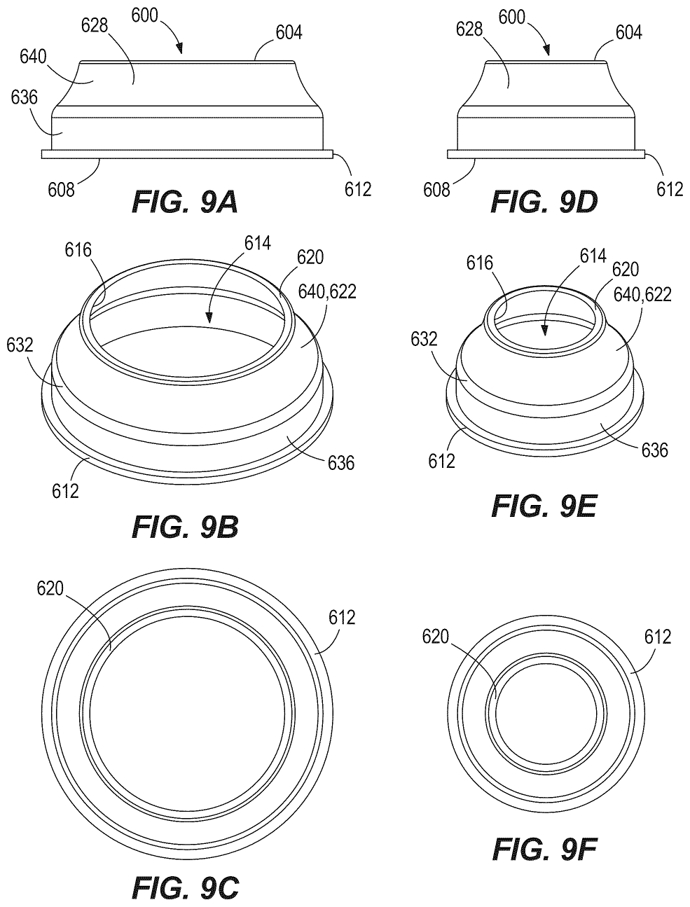

FIG. 9A-9F illustrate two sizes of a second style of cover 600. The second style of cover 600 is similar to the first cover 500. The second cover 600 extends between a front end 604 including a front face 620 and front opening 616, and a rear end 608 including a flange 612. A cover channel 614 extends through a central body 628 having an outer surface 632. In the second style of cover 600, the front face 620 is a rim surrounding the opening, and the outer surface 632 includes a cylindrical portion 636 and a curved portion 640 that extends into the front face 620. The curved portion 640 generally tapers from the cylindrical portion 636 to the front face 620. As shown, the cylindrical portion 636 includes a uniform outer diameter, while the curved portion 640 has an outer dimension that varies from the cylindrical portion 636 to the front face 620. During operation, the curved portion 640 forms at least a portion of the contact surface 622 and engages the stop surface 164. Specifically, the curved portion 640 nests partially within the operator's fist.

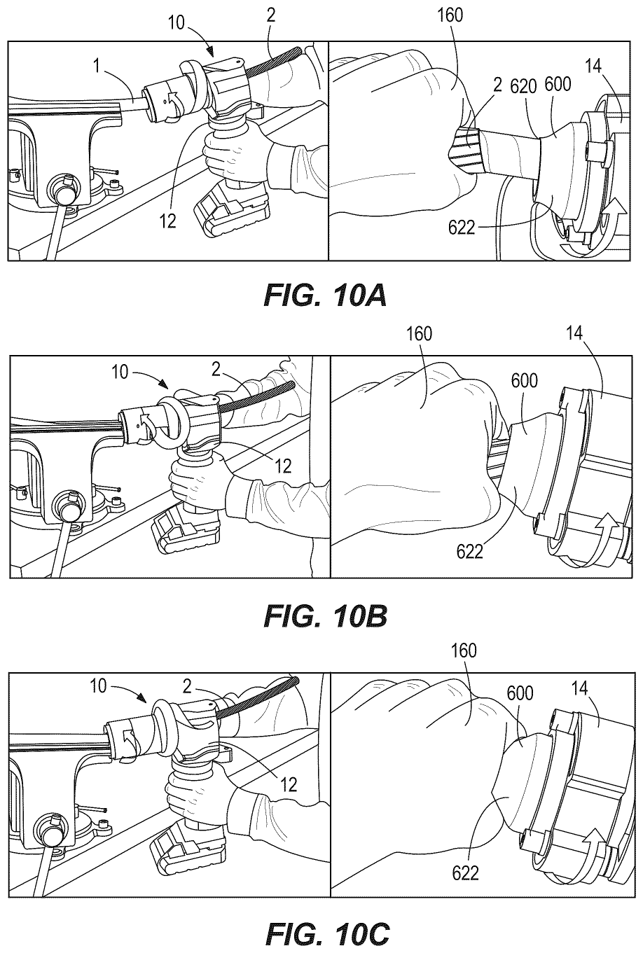

FIGS. 10A-10C illustrate the process of terminating the stripping operation using a cover 600. In FIG. 10A, the bushing 14 continues rotating and the assembly 10 travels along the cable. With reference to FIG. 7B, as the assembly 10 approaches the stop point, a front face 620 of the cover 600 is advanced toward the stop point such that the contact surface 622 comes into contact with the stop surface 164 of the stop member 160. As noted above, in this embodiment, the contact surface 622 nests partially within the operator's fist. Like the contact surface 522 of the cover 500, the contact surface 622 is a high friction surface and the engagement of the stop surface 164 and the contact surface 622 inhibits movement of the cover 600 with respect to the stop member 160 and the cable 1. The bushing 14 therefore rotates with respect to the cover 600 and the blade assembly 134 continues to circumnavigate the cable 1. The stop member 160 is inhibited from moving along the cable and therefore applies an axial force to the assembly 10 to inhibit the assembly 10 from moving along the cable. Thus, rotation of the bushing 14 moves the blade assembly 134 to create a circumferential cut, separating the coil of removed cable layers 3, 4 from the cable 1. Once the coil 3 has been removed, the exposed cable end 6 can travel the pathway 146 in reverse, and the assembly 10 can be removed from the cable 1. In some embodiments, the reverse movement may come from a reverse movement of the motor 70.

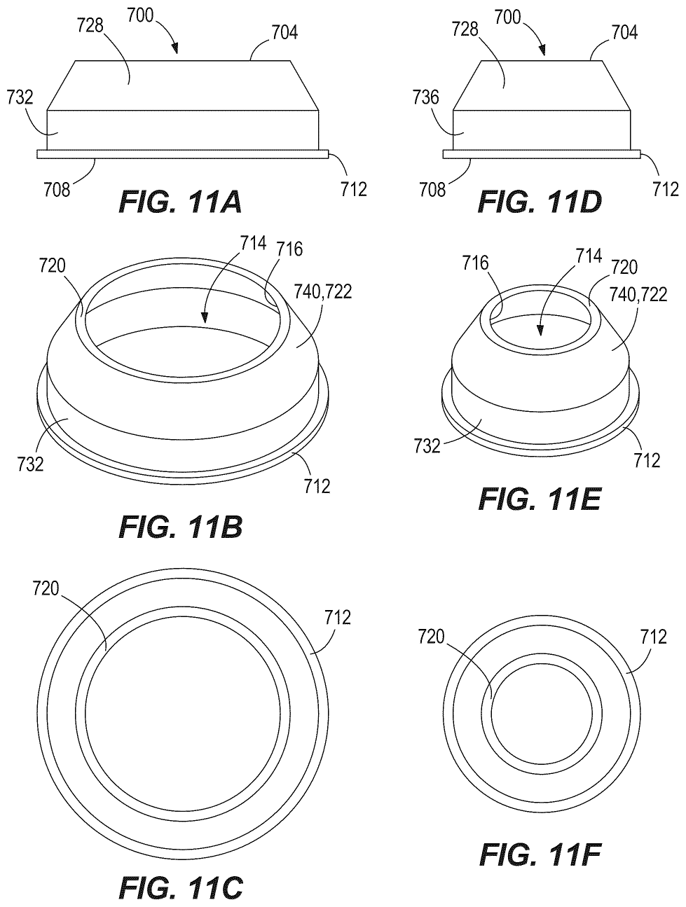

FIG. 11A-11F illustrate two sizes of a third style of cover 700. The third style of cover 700 is similar to the second cover 600. The third cover 700 extends between a front end 704 including a front face 720 and front opening 716, and a rear end 708 including a flange 712. A cover channel 714 extends through a central body 728 having an outer surface 732. In the third style of cover 700, the front face 720 is a rim surrounding the opening 716, and the outer surface 732 includes a cylindrical portion 736 and an angled portion 740 that extends into the front face 720. The angled portion 740 generally tapers from the cylindrical portion 736 to the front face 720. As shown, the cylindrical portion 736 includes a uniform outer diameter, while the angled portion 740 has an outer dimension that varies from the cylindrical portion 736 to the front face 720. During operation, the angled portion 740 forms the contact surface 722 and engages the stop surface 164. Specifically, the angled portion 740 nests partially within the operator's fist.

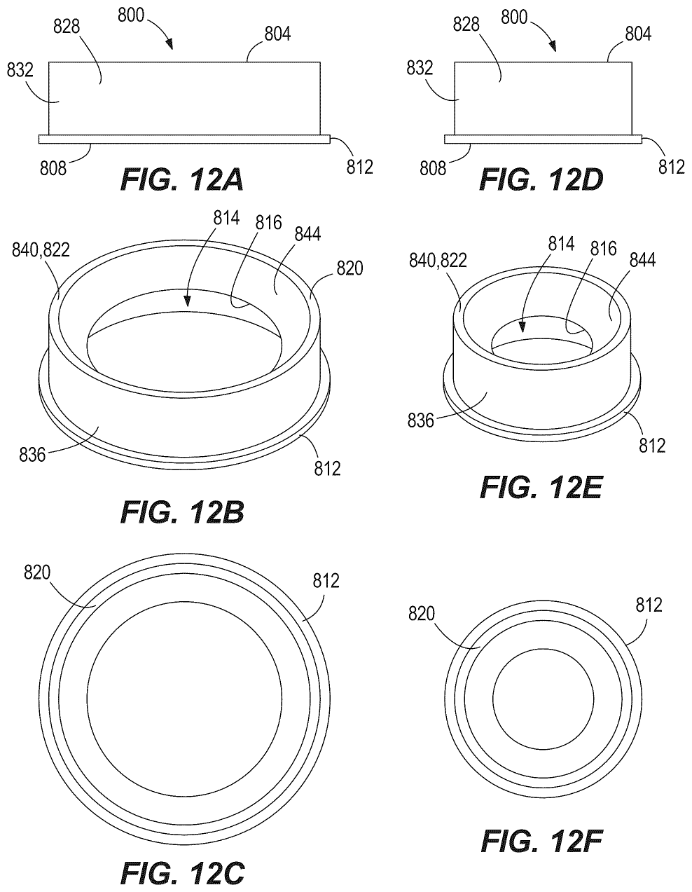

FIG. 12A-12F illustrate two sizes of a fourth style of cover 800. The fourth style of cover 800 is similar to the first cover 500. The fourth cover 800 extends between a front end 804 including a front face 820 and front opening 816, and a rear end 808 including a flange 812. A cover channel 814 extends through a central body 828 having an outer surface 832. In the fourth style of cover 800, the outer surface 832 includes a cylindrical portion 836. The front face 820 includes a rim portion 840 and a recessed portion 844. The recessed portion 844 generally tapers from the front face 820 towards the cover rear end 808. As shown, the recessed portion 844 has an outer dimension that varies from the front face 820 towards the cover rear end 808. During operation, the rim portion 840 forms the contact surface 822 and engages the stop surface 164. Specifically, the recessed portion 844 minimizes the size of the contact surface 822, decreasing contact between the cover 500 and the stop member 160 and therefore decreasing rubbing therebetween.

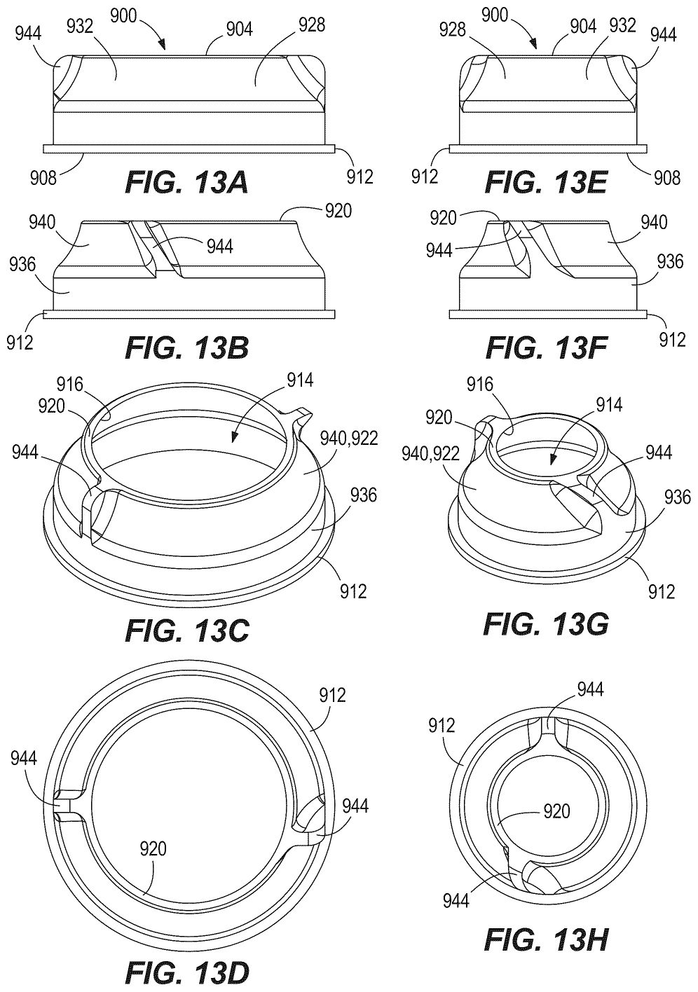

FIG. 13A-13H illustrate two sizes of a fifth style of cover 900. The fifth style of cover 900 is similar to the second cover 600. The fifth cover 900 extends between a front end 904 including a front face 920 and front opening 916, and a rear end 908 including a flange 912. A cover channel 914 extends through a central body 928 having an outer surface 932. In the fifth style of cover 900, the front face 920 is a rim surrounding the opening 916, and the outer surface 932 includes a cylindrical portion 936 and a curved portion 940 that extends into the front face 920. Additionally, the central body 928 includes radially extending tabs 944 positioned on the curved portion 940. The illustrated cover 900 includes two tabs 944. The tabs 944 are positioned diametrically opposite each other. One of the tabs 944 extends generally parallel to a central longitudinal axis of the cover 900, while the other tab 944 is obliquely angled relative to the central longitudinal axis of the cover 900. In other embodiments, the cover 900 may include fewer or more tabs. Additionally or alternatively, the tabs 944 may have other configurations (e.g., both parallel to the central longitudinal axis, both obliquely angled relative to the central longitudinal axis, unequally spaced about the cover 900, etc.). During operation, the curved portion 940 forms the contact surface 922 and engages the stop surface 164. Specifically, the curved portion 940 nests partially within the operator's fist and the tabs 944 engage the fist to inhibit rotation of the cover 900 with respect to the stop member 160.

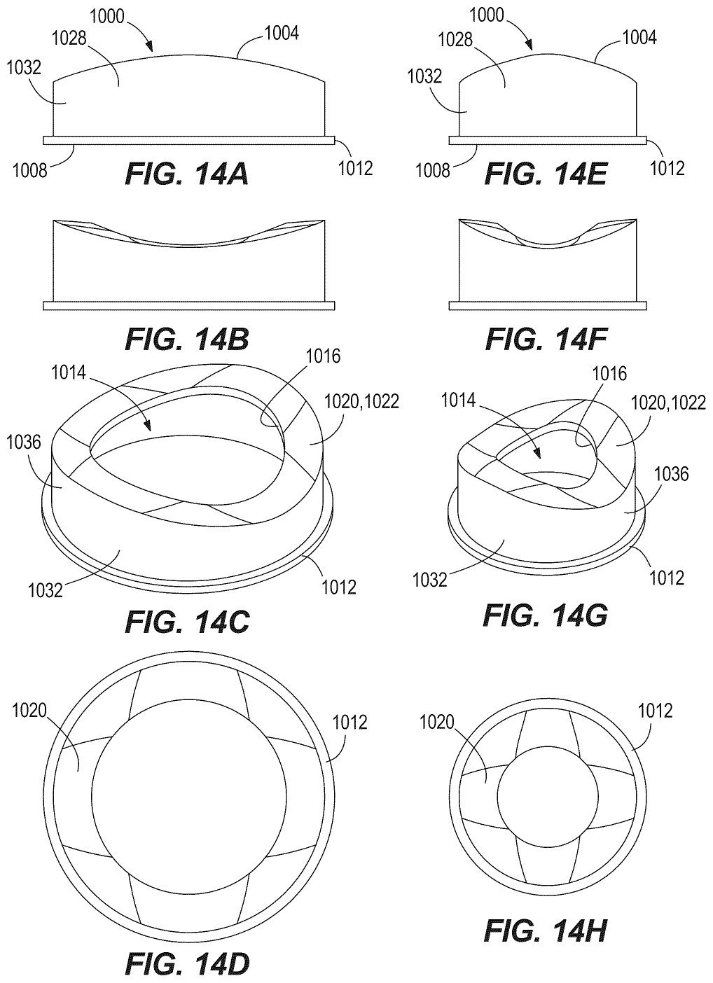

FIG. 14A-14H illustrate two sizes of a sixth style of cover 1000. The sixth style of cover 1000 is similar to the first cover 500. The sixth cover 1000 extends between a front end 1004 including a front face 1020 and front opening 1016, and a rear end 1008 including a flange 1012. A cover channel 1014 extends through a central body 1028 having an outer surface 1032. In the sixth style of cover 1000, the front face 1020 is wavy or undulated and the outer surface 1032 includes a cylindrical portion 1036. During operation, the wavy front face 1020 forms the contact surface 1022 and engages the stop surface 164. Specifically, the wavy profile of the front face 1020 matches the contours of the operator's fist to inhibit rubbing of the cover 1000 on the stop surface 164.

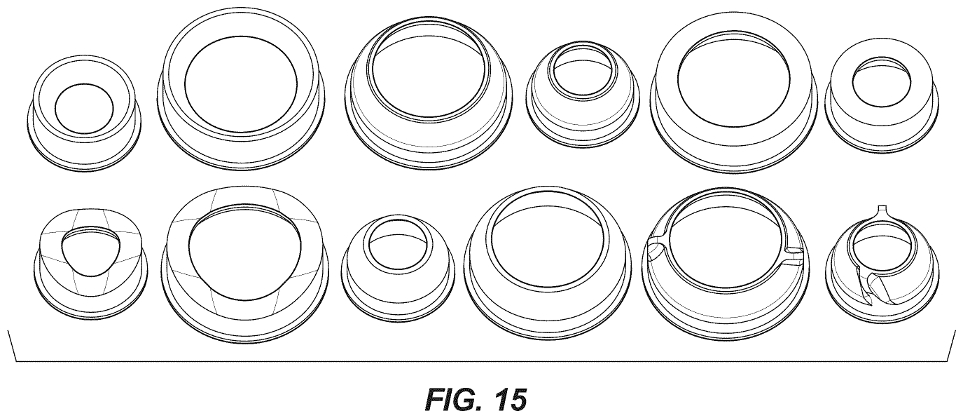

FIG. 15 illustrates an exemplary kit including a plurality of covers. In some embodiments, the covers are interchangeable and may be removably and alternately coupled to the bushing 14. In some embodiments, the connection includes is a quick coupling. In other embodiments, the covers may be more firmly connected to the bushing 14 and stored therewith, and a bushing/cover combination may be selected by the operator based on the cable size and properties. In still further embodiments, the covers may be formed with the bearing and sold therewith.

Thus, the present disclosure provides a cover for use with a cable stripping assembly to decrease rubbing between a stop member and the assembly.

Various features of the invention are set forth in the following claims.

What is claimed is:

1. A cable stripping tool assembly comprising:
a cable stripping tool including a housing and a drive mechanism disposed in the housing;
a bushing supported on the housing for rotation about a longitudinal axis by the drive mechanism, the bushing having a blade assembly engageable with a cable for stripping an insulation layer therefrom; and
a cover coupled to the bushing opposite the housing and supported for rotation about the longitudinal axis relative to the bushing, the cover including a contact surface configured to engage a stop member to inhibit rotation of the cover with respect to the cable.

2. The cable stripping tool assembly of claim 1, wherein the housing includes a coupling member that is rotatable about the longitudinal axis by the drive mechanism and configured to receive the bushing when the bushing is coupled to the housing.

3. The cable stripping tool assembly of claim 1, wherein the contact surface is formed on a front face of the cover.

4. The cable stripping tool assembly of claim 1, wherein the contact surface is part of an outer surface.

5. The cable stripping tool assembly of claim 1, wherein the contact surface includes a tab.

6. The cable stripping tool assembly of claim 1, wherein the bushing includes a groove in an inner surface thereof, wherein the cover includes a flange that is receivable within the groove of the bushing, and wherein the flange is rotatably supported within the groove to allow rotation of the cover relative to the bushing.

7. The cable stripping tool assembly of claim 1, wherein the cover is a first cover and the contact surface is a first contact surface, and wherein the first cover is removable from the bushing and replaceable with a second cover configured to be coupled to the bushing opposite the housing and supported for rotation about the longitudinal axis relative to the bushing, the second cover including a second contact surface configured to engage the stop member to inhibit rotation of the second cover with respect to the cable, the second cover having a different configuration than first cover.

8. A cable stripping tool assembly comprising:
a cable stripping tool including a housing and a drive mechanism disposed in the housing;
a bushing supported on the housing for rotation about a longitudinal axis by the drive mechanism, the bushing having a blade assembly engageable with a cable for stripping an insulation layer therefrom, the bushing including a first end coupled to the housing and a second end opposite the first end; and
a cover coupled to the bushing opposite the housing and supported for rotation about the longitudinal axis relative to the bushing, the cover including a first end rotatably coupled to the bushing and a second end spaced apart from the first end, the second end of the cover offset from the second end of the bushing, the cover including a contact surface configured to engage a stop member to inhibit rotation of the cover with respect to the cable.

9. The cable stripping tool assembly of claim 8, wherein the housing includes a coupling member that is rotatable about the longitudinal axis by the drive mechanism and configured to receive the first end of the bushing when the bushing is coupled to the housing.

10. The cable stripping tool assembly of claim 8, wherein the bushing includes a groove in an inner surface thereof, wherein the first end of the cover includes a flange that is receivable within the groove of the bushing, and wherein the flange is rotatably supported within the groove to allow rotation of the cover relative to the bushing.

11. The cable stripping tool assembly of claim 10, where the groove is positioned between the first end and the second end of the bushing.

12. The cable stripping tool assembly of claim 8, wherein the second end of the cover defines a front face, and wherein the contact surface is formed by the front face.

13. The cable stripping tool assembly of claim 8, wherein the contact surface is positioned between the first end of the cover and the second end of the cover.

14. The cable stripping tool assembly of claim 8, wherein the contact surface includes a tab extending from the second end of the cover towards the first end of the cover.

15. The cable stripping tool assembly of claim 8, wherein the cover is a first cover and the contact surface is a first contact surface, and wherein the first cover is removable and replaceable with a second cover configured to be coupled to the bushing opposite the housing and supported for rotation about the longitudinal axis relative to the bushing, the second cover including a second contact surface configured to engage the stop member to inhibit rotation of the second cover with respect to the cable, the second cover having a different configuration than first cover.

16. A kit for use with a cable stripping tool assembly, the cable stripping tool assembly including a cable stripping tool and a bushing, the cable stripping tool including a housing and a drive mechanism disposed in the housing, the bushing supported on the housing for rotation about a longitudinal axis by the drive mechanism, the bushing having a blade assembly engageable with a cable for stripping an insulation layer therefrom, the kit comprising:
a first cover including
a first end configured to be coupled to the bushing;
a second end opposite a first end;
a channel extending between the first end and the second end; and
a first contact surface configured to engage a stop member to inhibit rotation of the first cover with respect to the cable; and
a second cover including
a first end configured to be coupled to the bushing;
a second end opposite a first end;
a channel extending between the first end and the second end; and
a second contact surface configured to engage a stop member to inhibit rotation of the second cover with respect to the cable,
wherein the first cover and the second cover are alternately couplable to the bushing, and wherein the second cover has a different configuration than the first cover.

17. The kit of claim 16, wherein each of the first cover and the second cover includes a flange, the flange configured to be rotatably received within a groove of the bushing.

18. The kit of claim 16, wherein the first contact surface is defined at the second end of the first cover, and wherein the second contact surface is positioned between the first end and the second end of the second cover.

19. The kit of claim 16, wherein the second contact surface includes a tab extending from the second end towards the first end of the second cover.

20. The kit of claim 16, wherein each of the first contact surface and the second contact surface is a high friction contact surface.
